(19) United States
(12) Patent Application Publication
(10) Pub. No.: US 2012/0176497 A1
(43) Pub. Date: Jul. 12, 2012

(54) ASSISTING VEHICLE NAVIGATION IN SITUATIONS OF POSSIBLE OBSCURED VIEW

(75) Inventor: Ofir Shadmi, Shimshit (IL)

(73) Assignee: RAFAEL ADVANCEDEFENSE SYSTEMS LTD., Haifa (IL)

(21) Appl. No.: 13/395,442

(22) PCT Filed: Sep. 14, 2010
(86) PCT No.: PCT/IB10/54137

§ 371 Date: Mar. 11, 2012

(30) Foreign Application Priority Data
Oct. 1, 2009 (IL) 201336

(51) Int. Cl. H04N 7/18

(52) U.S. Cl. 348/144; 348/E07.085

(57) ABSTRACT

Restrictions of conventional techniques for assisting navigation of a vertical takeoff and landing vehicle in circumstances where there is a possibility of the view being obscured, can be overcome by using a three-dimensional model in combination with image processing to determine which segments of a landing zone are visible and which segments are obscured. A pilot is provided with a view of the landing zone that is a combination of live images and simulated segments from the three-dimensional model. Whereas conventional techniques focus on generating better simulated views, an implementation of this invention includes generating a view of an obscured landing zone that includes live imager. Fusing live imagery with other sensor information to generate a view allows the pilot to use a much real information as possible, and facilitates increased pilot confidence that the pilot can proceed and execute a successful landing.

### FIELD OF THE INVENTION

The present embodiment generally relates to the field of image processing and in particular, it concerns a system and method for using augmented reality to provide a view of an obscured landing zone.

### BACKGROUND OF THE INVENTION

Helicopters are required to land in a variety of locations. The main difficulty in the process of landing occurs during the final moments of the landing. During the final moments of a landing, it is critical that the pilot has knowledge of the landing site and the relation of his aircraft to the site. Experienced pilots relate that landing is the biggest challenge of flying their aircrafts, taking the greatest amount of training to learn and the greatest amount of skill to perform.

To execute a safe landing, pilots want to have the maximum possible amount of information about the landing site. Pilots want information and feedback as to where the ground and surrounding objects are in relation to the position of their aircraft. This information can include the makeup and slope of the terrain. In particular, pilots desire to see the real ground and surroundings as much as possible to have confidence that they can proceed and execute a successful landing.

If a helicopter is flying fast enough or high enough, the effects of small particles on the ground are not an issue. When a helicopter flies close enough to the ground, the downwash from the rotors can cause small particles on the ground to become airborne. When the helicopter's airspeed drops below the effective translational lift (ETL) speed, the helicopter is flying in its own recirculating downwash and airborne particles, or dust landing effects become an issue. These airborne particles can obscure the view of the ground, in particular the view of the landing zone. This condition is known as a dust landing, or brownout. In the context of this document, the term dust landing is used to refer to a landing or sufficiently low air speed of a helicopter where any small particle matter obscures the view of at least a portion of the landing zone. In this context, the concept applicable to a helicopter can also be applied to a tilt-wing aircraft or vehicle that operates similarly. The particles include dust, sand, snow, and materials that similarly cause obscuring of the landing zone. The landing zone includes any area that the vehicle is moving sufficiently close and sufficiently slowly to cause the view of that zone to be obscured. An example is a helicopter flying slowly over an area for close reconnaissance of the area.

The leading cause of landing accidents is related to dust landings. Experienced pilots relate that dust landings are the biggest challenge of their flight experience.

In the decade from 1990 to 2000, the U.S. Army recorded over 40 cases of dust landing accidents during training. Since 1991, there have been over 230 cases of aircraft damage and/or injury due to unsuccessful take-offs or landings in a dust environment. Helicopter dust landings are a US$100 million per year problem for the U.S. Military in Afghanistan and Iraq. The U.S. Army cites brownout in 75% of helicopter accidents there. As one example, dust-landing accidents destroyed or severely damaged four AH-64D Apache Longbows in the first three weeks of the 2003 Iraq invasion, while only one had been lost in combat. United States Army personnel have been quoted as saying that dust landings remain the biggest threat faced by helicopter pilots.

Improved tactics, techniques, and procedures have been shown to be able to reduce dust-landing incidents, but a system is needed to further reduce, and hopefully eliminate, dust-landing incidents.

A variety of conventional techniques are in use to assist pilots with dust landings. One conventional solution is to prepare the landing area for the aircraft. Preparations include illuminating the landing zone, notating the landing zone, or coating or otherwise preparing the surface of the landing zone. These solutions require that the landing zone be known ahead of time and sufficient resources and time are available to prepare the landing zone.

Background of the problem and conventional solutions are recited in European patent EP1906151A2 to Ferren ET. AL. for an Imaging and display system to aid helicopter landings in brownout conditions. This patent teaches an imaging and display system that constructs a diagram of a landing area that provides helicopter pilots with an unobstructed display of a landing area in a brownout conditions. The technique captures a high-resolution image of the landing area prior to obscuration. Using inertial navigation information the system transforms the image to the desired viewpoint and constructs a diagram representing the helicopter's current position relative to the landing area. The pilot can refer to the display of this diagram for information to assist with a dust landing. The display does not include a real image of the landing area and hence does not provide the pilot with the confidence needed to proceed with a landing.

One conventional system for helping pilots overcome dust-landing conditions is the Sandblaster system under development by Sikorsky Aircraft Corporation. The Sandblaster system adds a 94 GHz radar to a helicopter, in combination with a synthetic-vision cockpit display, a database of knowledge about the ground below and integrated flight controls. A pilot presses a button to engage the automated flight controls, which bring the helicopter from en route flight to a low hover and ensure minimal drifting above a pre-programmed landing point. During landing, the Sandblaster's radar sees through the dust to detect the terrain and objects in the landing zone. The Sandblaster system then employs the radar imagery and a database of knowledge about the ground below to produce a three-dimensional view of the landing zone and surroundings on the synthetic vision cockpit display. This system requires adding additional hardware to a helicopter, as well as knowing ahead of time where the landing zone will be and having a corresponding database of the landing zone.

There is therefore a need for a system and method to reduce helicopter accidents resulting from blinding flight conditions such as dust landings. The system should preferably provide as much real imagery as possible to give a pilot confidence to proceed and execute a safe landing. It is an additional benefit to use imaging devices that already exist on an aircraft, and avoid the cost, time, and weight of installing additional hardware on the aircraft. It is an additional benefit to not require any pre-knowledge of the terrain or landing zone.

### SUMMARY

According to the teachings of the present embodiment there is provided a system for assisting navigation of a vertical takeoff and landing vehicle in circumstances where there is a possibility of the view being obscured, including: an image capture system including at least one image capture device, the image capture system associated with the vehicle and configured to provide images of a landing zone; a navigation system providing the attitude and position of the vehicle; a processing system including one or more processors, the processing system being configured to: provide a three-dimensional model of the landing zone; process images captured during the vehicle's landing at the landing zone to determine the visibility of segments of the current image of the landing zone; and render using the attitude and position an at least partial image including at least simulated segments derived at least in part from the three-dimensional model of the landing zone, the at least partial image configured for providing the user with a perceived composite view for assisting navigation of the vehicle, the perceived composite view including the simulated segments and an updated real view of at least part of the landing zone; and a display system configured to display the at least partial image so as to provide the perceived composite view to the user.

In an optional embodiment, the display system is configured to display the at least partial image as a composite of the simulated segments with segments of the current image for visible segments of the landing zone. In another optional embodiment, the display system includes a head up display (HUD), and wherein the at least partial image of the landing zone is viewed directly through the HUD. In another optional embodiment, the image capture system includes an image capture device sensitive to visible light. In another optional embodiment, the image capture system includes a forward-looking infrared (FLIR) camera. In another optional embodiment, the image capture system includes RADAR that provides information for generation of the three-dimensional model of the landing zone. In another optional embodiment, the image capture system includes LADAR that provides information for generation of the three-dimensional model of the landing zone. In another optional embodiment, a digital terrain map (DTM) provides information for generation of the three-dimensional model of the landing zone. In another optional embodiment, the image capture system includes a plurality of image capture devices. In another optional embodiment, the three-dimensional model is provided by processing a first plurality of the images during the vehicle's approach to the landing zone. In another optional embodiment, the three-dimensional model is provided to the processing system from storage.

In another optional embodiment a second plurality of images are captured during the vehicle's approach to the landing zone and the second plurality of images are used to update the three-dimensional model.

In another optional embodiment, the system further includes a user actuated trigger for initiating the processing. In another optional embodiment the processing system is further configured to monitor the visibility of segments of the current image of the landing zone and based on a visibility threshold activate the rendering process and the display system. In another optional embodiment, the system is operationally connected to a system providing flight parameters and wherein the processing system is further configured to monitor the flight parameters and based on a combination of flight parameters activate the system for assisting navigation of the vehicle.

In another optional embodiment, the flight parameters include altitude and velocity. In another optional embodiment, the flight parameters include altitude and direction of flight.

In another optional embodiment, the navigation system determines the attitude and position of the vehicle at least in part from the images. In another optional embodiment, the navigation system determines the attitude and position of the vehicle at least in part from an inertial navigation system (INS). In another optional embodiment the during the vehicle's approach to the landing zone the images are stored in association with the surfaces of the three-dimensional model of the landing zone to which they correspond and the view of the landing zone is rendered using textures from the images.

According to the teachings of the present embodiment there is provided a method for assisting navigation of a vertical takeoff and landing vehicle in circumstances where there is a possibility of the view being obscured, the method including the steps of: providing images of a landing zone during a vehicle's approach to the landing zone; providing the attitude and position of the vehicle; providing a three-dimensional model of the landing zone; processing the images captured during the vehicle's landing at the landing zone to determine the visibility of segments of the current image of the landing zone; rendering using the attitude and position an at least partial image including at least simulated segments derived at least in part from the three-dimensional model of the landing zone, the at least partial image configured for providing the user with a perceived composite view for assisting navigation of the vehicle, the perceived composite view including the simulated segments and an updated real view of at least part of the landing zone; and the at least partial image so as to provide the perceived composite view to the user. In an optional embodiment, the at least partial image is displayed as a composite of the simulated segments with segments of the current image for visible segments of the landing zone. In an optional embodiment, the at least partial image of the landing zone is displayed for viewing directly through a head-up-display (HUD). In an optional embodiment, the images are visible-light images. In an optional embodiment, the images are infrared images. In an optional embodiment, the three-dimensional model of the landing zone is generated from RADAR information. In an optional embodiment, the three-dimensional model of the landing zone is generated from LADAR information. In an optional embodiment, the three-dimensional model of the landing zone is generated from digital terrain map (DTM) information. In an optional embodiment, the three-dimensional model is provided by processing a first plurality of the images during the vehicle's approach to the landing zone. In an optional embodiment, the three-dimensional model is provided from storage. In an optional embodiment, a second plurality of images are captured during the vehicle's approach to the landing zone and the second plurality of images are used to update the three-dimensional model. In an optional embodiment, the visibility of segments of the current image of the landing zone are monitored, and based on a visibility threshold, the rendering and the display steps are initiated. In an optional embodiment, the flight parameters are provided and further includes monitoring the flight parameters and based on a combination of flight parameters initiating the method for assisting navigation of the vehicle.

In an optional embodiment, the flight parameters include altitude and velocity. In an optional embodiment, the flight parameters include altitude and direction of flight. In an optional embodiment, the attitude and position of the vehicle are provided at least in part from the images. In an optional embodiment, the attitude and position of the vehicle are provided at least in part from an inertial navigation system (INS).

In an optional embodiment, during the vehicle's approach to the landing zone the images are stored in association with the surfaces of the three-dimensional model of the landing zone to which they correspond and the view of the landing zone is rendered using textures from the images.

### BRIEF DESCRIPTION OF FIGURES

The embodiment is herein described, by way of example only, with reference to the accompanying drawings, wherein:

FIG. 1A is a diagram of a vehicle approaching a landing zone.

FIG. 1B is a diagram of a vehicle approaching closer to a landing zone.

FIG. 1C is a diagram of a vehicle making a landing at a landing zone.

FIG. 1D is a diagram of a vehicle after landing at a landing zone.

FIG. 2 is a diagram of a system for assisting navigation of a vehicle in circumstances where there is a possibility of the view being obscured.

FIG. 3 is a flowchart of a method for assisting navigation of a vehicle in circumstances where there is a possibility of the view being obscured.

FIG. 4A is a diagram showing an unobscured view of a landing zone.

FIG. 4B is a diagram showing an obscured view of a landing zone.

FIG. 5A is a diagram of a monitor displaying a rendered view of the landing zone.

FIG. 5B is a diagram of a HUD displaying simulated segments of the landing zone.

### DETAILED DESCRIPTION

The principles and operation of this system and method according to the present embodiment may be better understood with reference to the drawings and the accompanying description. The present invention is a system and method for assisting navigation of a vehicle in circumstances where there is a possibility of the view being obscured. The following is a non-limiting description of the circumstances where this system and method are used.

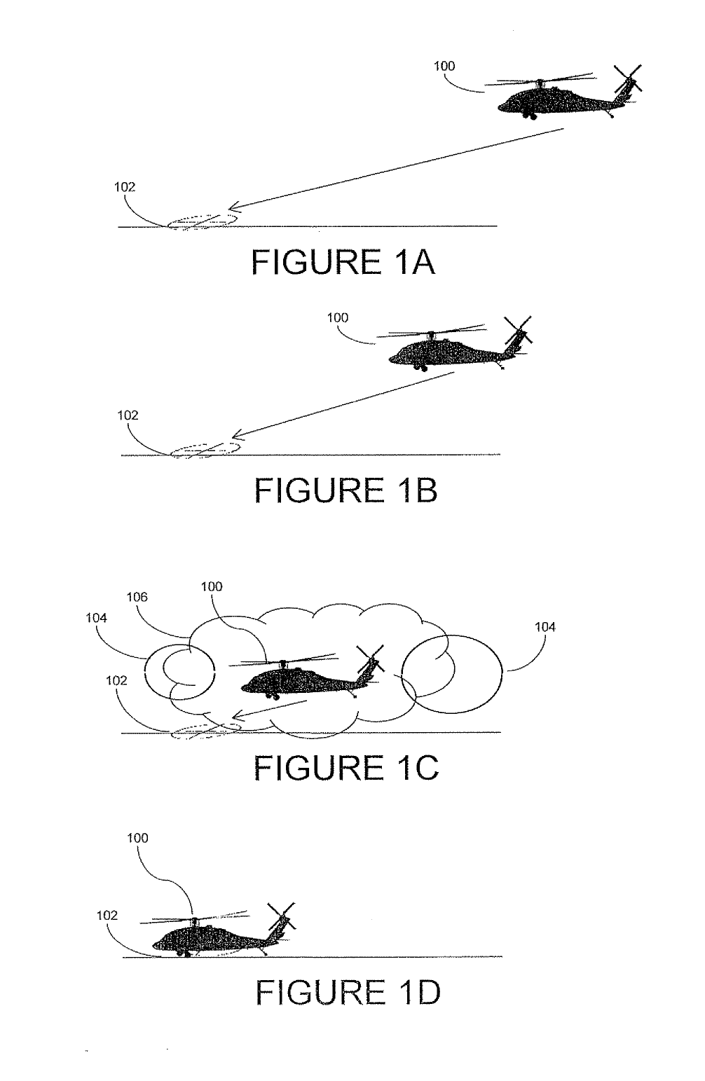

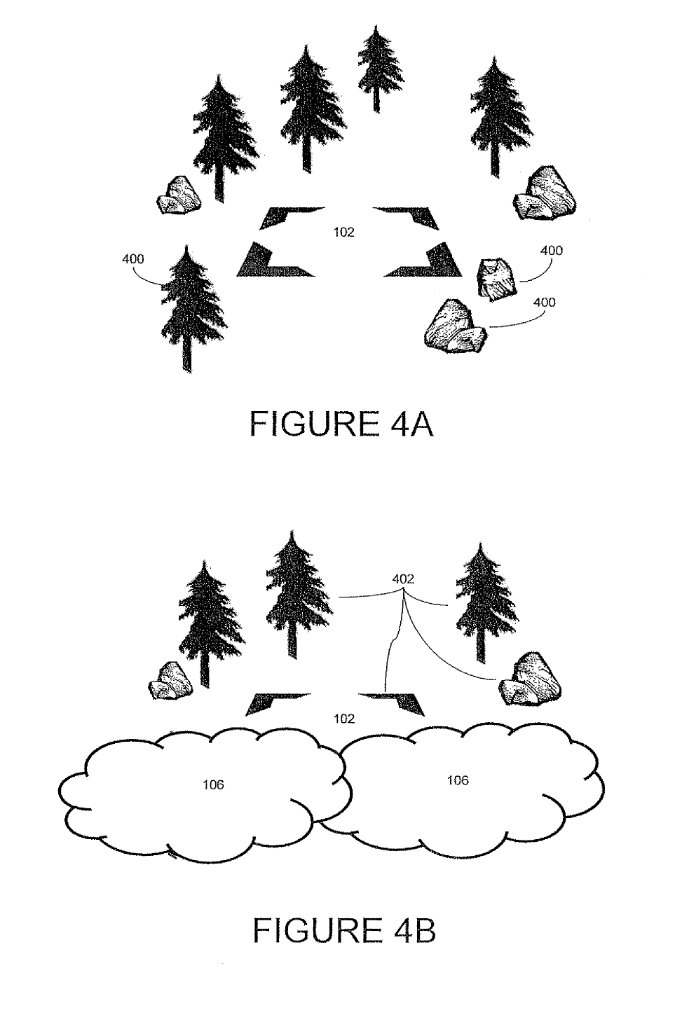

Referring to FIG. 1A is a diagram of a vehicle approaching a landing zone. In the context of this document, the term vehicle is used to refer to a vertical takeoff and landing vehicle (VTOL), such as a helicopter, tilt-wing aircraft, or craft that operates similarly. The concept of this invention can also be applied to different platforms in similar situations, such as landing a submersible craft on an ocean floor. The vehicle 100 has a view of the landing zone 102 from a distance. During the approach of the vehicle to the landing zone, the landing zone is visible and it is possible for unobscured images of the landing zone to be captured. Also, refer to FIG. 4A, a diagram showing an unobscured view of a landing zone.

Referring to FIG. 1B is a diagram of a vehicle approaching closer to a landing zone. As the vehicle 100 continues to approach the landing zone 102 from a distance the landing zone is still visible and it is possible to continue capturing unobscured images of the landing zone.

Referring to FIG. 1C is a diagram of a vehicle making a landing at a landing zone. As the vehicle 100 gets close to the landing zone 102, depending on surface and environmental conditions, downwash from the rotors 104 can cause small particles on the ground to become airborne. These airborne particles 106 can obscure the view of the ground, in particular the view of the landing zone and dust-landing effects become an issue. Also refer to FIG. 4B, a diagram showing an obscured view of a landing zone. The view from the vehicle and images captured are partially or totally obscured by the effects of the dust landing.

Referring to FIG. 1D is a diagram of a vehicle after landing at a landing zone. The vehicle 100 has been successfully navigated and a successful landing has been made at the landing zone 102.

Conventional techniques to assist during a dust landing provide simulated views or diagrams of the landing zone, while pilots prefer to have as much real imagery as possible to assist in navigation. During a landing, if a pilot has to disregard all real information and depend on a simulated image, it is possible that the pilot will lack the confidence to proceed and execute a successful landing.

Conventional techniques also may require knowing the location of the landing zone ahead of time and having a digital terrain map (DTM) of the landing zone. Other techniques require the addition of sometimes-substantial hardware to the vehicle.

The restrictions of conventional techniques can be overcome by use of an innovative system and method for using a three-dimensional model in combination with image processing to determine which segments of the landing zone are visible and which segments are obscured, and providing a pilot with a view of the landing zone that is a combination of live images and simulated segments from the three-dimensional model. Whereas conventional techniques focus on generating better-simulated views, an implementation of this invention includes generating a view of an obscured landing zone that includes live imagery. Fusing live imagery with other sensor information to generate a view allows the pilot to use as much real information as possible, and facilitates increased pilot confidence that the pilot can proceed and execute a successful landing.

In addition, the technique of this invention facilitates providing a pilot with a smooth transition from live images to an image with simulated information. This occurs during the critical seconds of the landing and avoids the shift in perception of the landing area that a pilot would have if the pilot needed to switch from a live view, or live imagery, to a simulated view of the landing zone.

In addition, relatively small objects in the landing zone can be an issue that affects the safe landing of a vehicle. The operation of the pilot can be highly influenced by the details given in a provided view of the landing zone. Warping two-dimensional images or having to switch between multiple sensor information and/or displays does not provide a consistent and accurately detailed view of the landing zone. Using a three dimensional model of the landing zone facilitates providing detailed information that can be accurately generated as the position of the vehicle changes.

In addition, whereas some conventional techniques require prior knowledge of the landing zone, and possibly detailed information such as a digital terrain map (DTM) of the landing zone, an implementation of this invention does not require such prior knowledge or information.

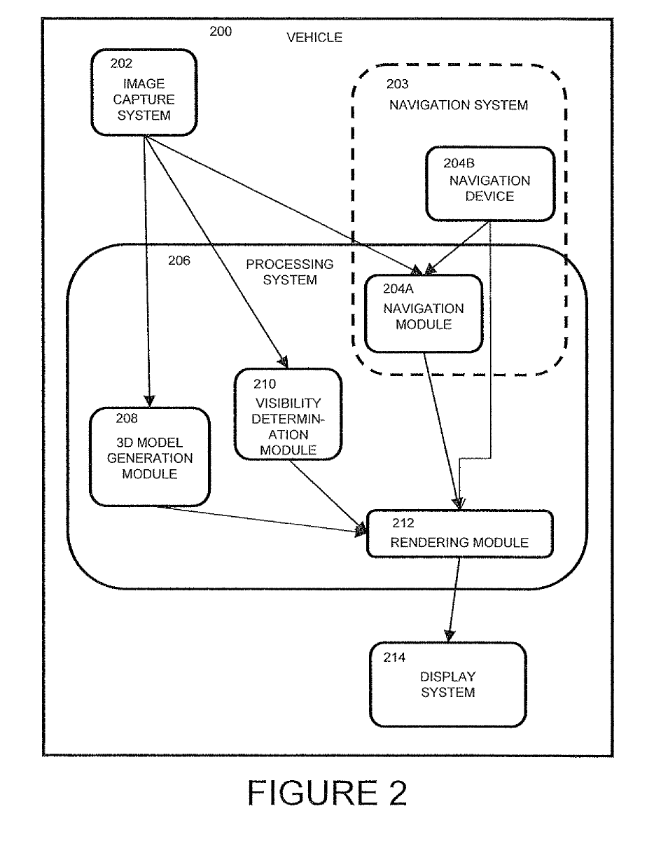

Referring to FIG. 2 is a diagram of a system for assisting navigation of a vehicle in circumstances where there is a possibility of the view being obscured. A vehicle 200 includes an image capture system 202, a navigation system 203, a processing system 206, a three-dimensional model generation module 208, a visibility determination module 210, a rendering module 212, and a display system 214. The navigation system 203 optionally includes a navigation module 204A, and/or navigation device 204B. Referring additionally to FIG. 1A, as the vehicle 100 approaches a landing zone 102 the image capture system 202 includes at least one image capture device and supplies images of the landing zone. The navigation system 203 provides the attitude and position of the vehicle. A processing system 206 contains one or more processors configured to process images during the vehicle's approach to the landing zone. A three-dimensional model generation module 208 processes captured images during the vehicle's approach to the landing zone to generate a three-dimensional model of the landing zone. The attitude and position of the vehicle are optionally provided by a navigation module 204A that processes captured images, a navigation device 204B that includes a capability for determining attitude and position information, or a combination of components. The image capture system 202 continues to capture images as the vehicle approaches the landing zone and throughout the landing. The processing system 206 continues to generate and/or improve the detail of the three dimensional model as the vehicle approaches the landing zone. Referring additionally to FIG. 4A, the unobscured view of the landing zone 102 includes obstacles such as 400.

Referring additionally to FIG. 1C, as the vehicle approaches the landing zone, in our case a dust-landing situation occurs. Referring additionally to FIG. 4B, the obstacles 400 (form FIG. 4A) are no longer visible due to the dust clouds 106. The area of objects 402 is not obscured and is visible to the user. The processing system 206 continues real-time processing of captured images during the vehicle's landing at the landing zone. A visibility determination module 210 processes captured images during the landing to determine the visibility of segments of the current image of the landing zone. Real-time refers to performing steps such as capturing, processing, and displaying images according to the limitations of the system. Typically, live images or live video are images and video that are handled in real-time, that is, they are captured, processed, and the resulting image displayed to the user with a delay according to the limitations of the handling system, typically with a delay of a fraction of a second. Preferably, real-time processing is implemented with a delay small enough so that the image displayed to the user is substantially contemporaneous with the view of the user. In the context of this document, the current image is the most recent live image. Note that it may not be necessary to process every captured image. Depending on the specific application and devices used, the captured images can be decimated, or other techniques know in the art used, to provide sufficient images for the specific application.

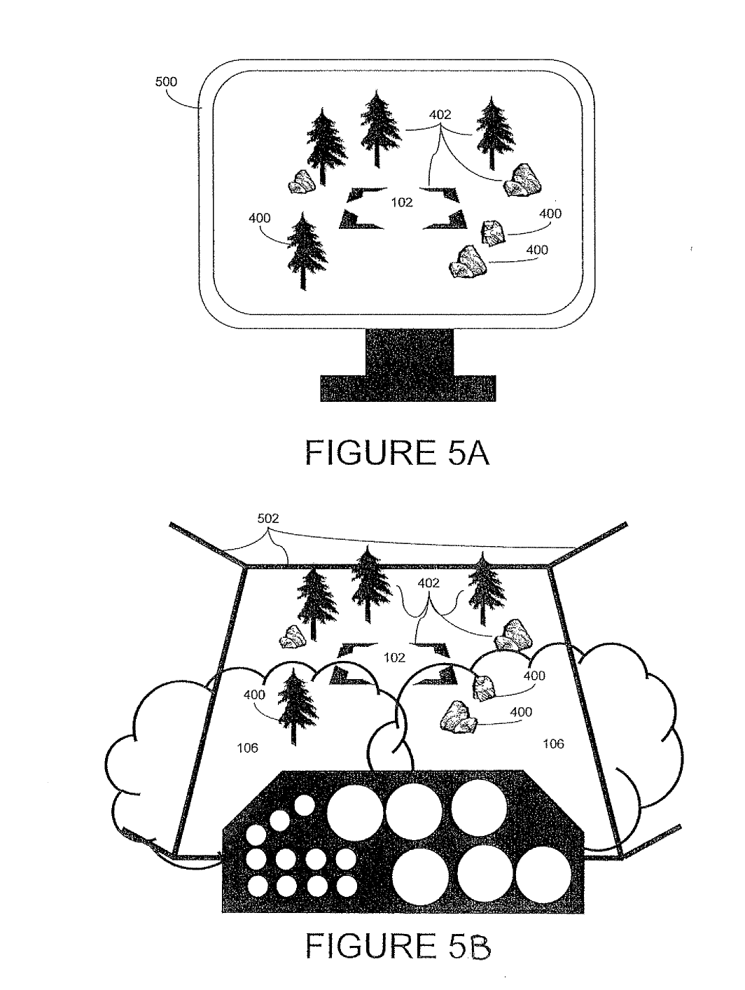

During approach and landing, a rendering module 212 uses the three-dimensional model in combination with visibility information, and the attitude and position of the vehicle to render an augmented reality view of the landing zone. In this context, augmented reality (AR) is a field of computer research that deals with the combination of real world and computer-generated data, where computer graphics are combined with live images in real time. Augmented reality includes the use of live images that are digitally processed and “augmented” by the addition of computer-generated graphics. A variety of techniques is known in the art for augmenting the live images, including blending, weighted average, and transparency. The rendered view of the landing zone is a combination of segments of the current image for visible segments of the landing zone with simulated segments from the three-dimensional model for segments of the landing zone that are obscured. The rendered view provides sufficient information to provide a view of the obscured landing zone. The view can be displayed on a display system 214. Referring to FIG. 5A, a diagram of a monitor displaying a rendered view of the landing zone, a display 500 displays segments of the current image where the landing zone is visible, such as the area of objects 402, and displays simulated segments for obscured segments of the current image. In this non-limiting example diagram, the dust cloud 106 has been removed from the obscured segments and the view is rendered in which the terrain and obstacles 400 are displayed. In an implementation where a head-up-display (HUD) is being used, the rendering module 212 determines the segments that are obscured and provides simulated segments to the display system 214 for display in the user's view. In the context of this document, HUD includes fixed and helmet mounted displays. Refer to FIG. 5B, a diagram of a HUD displaying simulated segments of the landing zone. In this non-limiting example diagram, the HUD display is aligned with the windshield 502 of the vehicle. In another implementation, the simulated segments are displayed using a helmet-mounted display. The user sees the landing zone where visible, such as the area of objects 402. Simulated segments are displayed for obscured segments of the landing zone. The dust cloud 106 is visible to the user, with obstacles such as 400 displayed by the HUD. Referring additionally to FIG. 1D, the rendered view can be used to proceed with, and execute a successful landing at the desired landing zone 102.

The image capture system 202 can include a variety of devices to provide two-dimensional images for processing, depending on the specific application of the system. If the vehicle has an existing image capture system, the system may be able to use the existing image device or devices. This eliminates the need to add additional hardware to the vehicle. In an optional implementation, the image capture system includes an image capture device sensitive to visible light. The image capture device can be mounted in a variety of locations on the vehicle, depending on existing devices or the specific application of the system. A vehicle mounted image capture device can be fixed or guided (for example gimbaled so an operator can control its direction). In another implementation, the image capture device can be mounted on the head of the pilot, such as the case where the helmet of the pilot contains a camera. Alternate implementations will be obvious to one skilled in the art.

In an alternate implementation, the image capture system includes RADAR that provides information for generation of the three-dimensional model of the landing zone. In another alternate implementation, the image capture system includes a LADAR that provides information for generation of the three-dimensional model of the landing zone.

In one implementation, the image capture system includes a plurality of image capture devices. The image capture devices can be similar, such as the case where multiple cameras provide two-dimensional images from their respective locations. Optionally, a mixture of image capture devices can be used, such as the case where one or more cameras provide two-dimensional images, and RADAR provides additional information for generation of the three-dimensional model.

In one implementation, the image capture system is configured to capture images during the vehicle's approach to the landing zone. Optionally, the two-dimensional images can be provided from storage. Images from storage can be from a variety of sources, such as in the case where another vehicle preceded the landing vehicle to the landing zone, or images of the landing zone are captured during the day to facilitate a night landing. In the case where the three-dimensional model is generated from stored images, when the first set of images are initially captured to be stored it is not necessary for the system to render the three-dimensional model, render a view, nor display the rendered view at the time the first set of images are captured. In this same case, it is preferred to capture live images during the approach to the landing zone and use these live images to confirm and update the three-dimensional model.

Note that the image of the landing zone should include capturing an image of an area of sufficient size for the vehicle to proceed and execute a safe landing. The size of the area will depend on the specific application of the system and the conditions in which the system is used.

In one implementation, the system includes a user actuated trigger for initiating the processing. According to a non-limiting example, as the pilot approaches the landing site, the pilot actuates a trigger to activate the system. Depending on the application, manual activation can initiate the entire system to start capturing images, or in another application the system is continually capturing images and processing and activation of the trigger initiates the rendering and display portion of the system. In certain cases, a user needs to designate the landing zone to the system. Depending on the application, a pointing device, touch-screen, or other appropriate device can be used by the user to designate the landing zone. Based on this description, additional options will be clear to one knowledgeable in the field.

In another implementation, the system is automatically activated. Automatic activation can be based on a variety of parameters depending on the application of the system. Optionally, the system monitors the view of the landing site and determines how much of the view is obscured by dust. When the percentage of the view exceeds a given threshold, the system activates a display to provide the pilot with a rendered view of the landing site. Optionally, the system is operationally connected to a system providing flight parameters such as altitude, velocity, attitude, and direction of flight. In this case, the processing system monitors the flight parameters and based on a combination of flight parameters activates the system for assisting navigation of the vehicle. Automatic activation can be based on a combination of one or more flight parameters. In one implementation, the system is activated based on a combination of altitude and velocity, for example when a vehicle decreases velocity and altitude during landing. In another implementation, the system is activated based on a combination of altitude and direction of flight, for example where a low-flying vehicle turns around. Depending on the specific implementation of the system, activation can include turning on the image capture system, starting the processing, queuing the navigation system, activating a display, altering an already operational display, and/or providing an indicator to the pilot.

The system includes a display system, and the processing module is configured to display the rendered view on the display system. If the vehicle has an existing display system, the system may be able to use the existing display device or devices. This eliminates the need to add additional hardware to the vehicle. If it is necessary or desirable to add a display device to a vehicle, a variety of display devices exist, and one skilled in the art can choose a display device suitable for the specific application of the system.

A navigation system 203 provides attitude and position information for the vehicle. In an alternate implementation, the navigation module 204A determines the attitude and position of the vehicle from the captured images. In this case, the navigation module 204A processes images from the image capture system 202. In another alternate implementation, a navigation device 204B determines the attitude and position of the vehicle from an inertial navigation system (INS). In this case, the navigation device 204B contains its own capability to provide the attitude and position of the vehicle. If the vehicle has an existing navigation system, the system may be able to use the existing navigation device. This eliminates the need to add additional hardware to the vehicle. If it is necessary or desirable to add a navigation device to a vehicle, a variety of navigation devices exist, and one skilled in the art can choose a navigation device suitable for the specific application of the system. Note that the use of a navigation device is not exclusive. More than one navigation device can be used, and it is possible to switch between navigation devices or use a combination of navigation information. The navigation system can use a combination of sensors, processing, and techniques to provide the attitude and position of the vehicle.

In one implementation, the vehicle includes a high-quality navigation device. In this context, a high-quality navigation device means that the navigation information supplied is sufficiently accurate for the specific application of the system. In a non-limiting example, navigation information from a high-quality navigation device is sufficient to maintain pixel-resolution spatial registration between real time images and the view rendered by the system. In another implementation, the vehicle includes a low-quality navigation device. In this context, a low-quality navigation device means that the navigation information supplied is not sufficiently accurate for the specific application of the system. The low-quality navigation information can be used in combination with a navigation module that performs image processing of captured images to provide sufficiently accurate information on the attitude and position of the vehicle for the specific application. Image processing for navigation can be used when the images contain visible segments of the landing zone or visible segments that correlate to the three-dimensional model of the landing zone. In a case where the images are obscured beyond a given threshold, navigation information is supplied by an inertial navigation system (INS). Depending on the application, if the vehicle has an existing INS, the vehicle's INS can be used. Optionally, an INS can be added to the vehicle. The navigation system can be a stand-alone device, a module configured to run on one or more processors in the system, or a combination of implementations. The navigation system 203 provides position and attitude information to the rendering module 212.

In an alternate implementation, during the vehicle's approach to the landing zone textures of terrain are captured and stored in association with surfaces of the three-dimensional model. During the vehicle's landing, the textures are overlaid with the three-dimensional model to render a view of the landing zone.

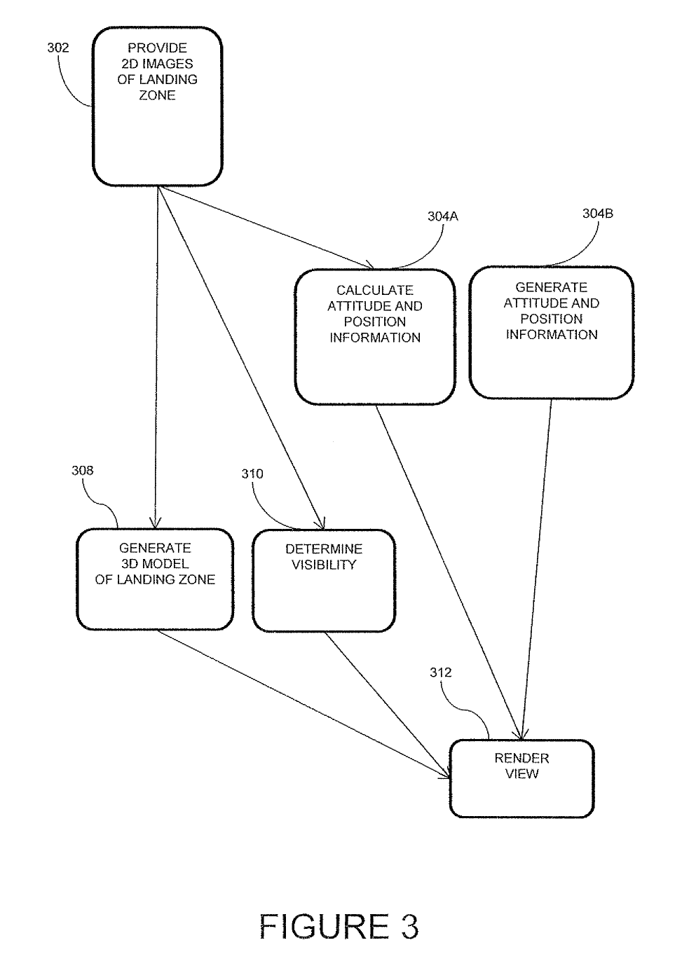

Referring to FIG. 3 is a flowchart of a method for assisting navigation of a vehicle in circumstances where there is a possibility of the view being obscured. Two-dimensional images of the landing zone are provided in block 302 and sent to be used to calculate the attitude and position information of the vehicle in block 304A. The images are also sent to generate a three-dimensional model of the landing zone in block 308, and sent to determine the visibility of the landing zone in block 310. The attitude and position can also be provided in part or in combination with an alternative process, shown in block 304B. The attitude and position information, three-dimensional model, and visibility information are used to render a view of the landing zone, shown in block 312.

The images provided in block 302 are used to generate a three-dimensional model of the landing zone, shown in block 308. In one implementation, the three-dimensional model is generated and updated as subsequent images of the landing zone are processed. In the case where the initial images of the landing zone are captured relatively far away from the landing zone, the initial images are used to generate a preliminary three-dimensional model of the landing zone. Subsequent images that are captured as the vehicle continues to approach the landing zone may be used to update the preliminary three-dimensional model to add new objects to the three-dimensional model in the relative positions of the objects and update details of the three-dimensional model. Super-resolution is an example of one known technique that can be used to increase model detail.

Techniques for generating a three-dimensional model from two-dimensional images are known in the art. One conventional technique is to use structure from motion (SFM) to generate the model. SFM generates a sparse model, and SFM post-processing can be used to increase model detail. Super-resolution is another known technique that can be used to increase model detail. Optical flow is another conventional technique that can be used to generate the model, although implementations of optical flow techniques in this field generally do not provide a sufficiently accurate detailed three-dimensional model. Techniques that provide better three-dimensional models include using linear and non-linear triangulation. These and other techniques for generating three-dimensional models of scenes are known in the industry.

In an alternative implementation, the technique of simultaneous location and mapping (SLAM) is used. SLAM is a technique to generate a model of an unknown environment (without a priori knowledge) or a known environment (with a priori knowledge) while at the same time keeping track of the current location. In one implementation, SLAM uses the images provided by block 302, to calculate attitude and position information, block 304A, and facilitate generating the three-dimensional model of the landing zone, block 308. SLAM is particularly useful in the case where the generated attitude and position information, block 304B, is not accurate enough to be used of itself. As can be done with all navigation information, SLAM can be used during the approach and landing to continuously provide information and corrections to the vehicle's attitude and position in relation to the three-dimensional model and the landing zone.

In an alternate implementation, RADAR information of the landing zone is provided for generation of a three-dimensional model of the landing zone. In another alternate implementation, LADAR information of the landing zone is provided for generation of a three-dimensional model. In another alternate implementation, database information, such as a digital terrain map, of the landing zone is provided for generation of a three-dimensional model. In implementations where three-dimensional information of the landing zone is provided, such as from RADAR or LADAR, two-dimensional images are also provided for both details of the three-dimensional model and for rendering a view from the three-dimensional model. Three-dimensional information can be used for the model structure and to detect obstructions, while the two-dimensional images are used for the real image in visible segments of the landing zone.

As has been described, this system and method do not need to know the landing zone ahead of time and do not need a database of the landing zone such as a digital terrain map. If a priori data is available, it can be used. In a general case, however, all of the necessary information about the landing zone can be derived from captured images.

The images provided in block 302 are used to determine the visibility of the landing zone, shown in block 310. As the vehicle approaches the landing zone, in some of the images, the landing zone can be visible, in some of the images, the landing zone can be partially obscured, and in some of the images, the landing zone can be totally obscured. Visibility can be determined in a variety of ways depending on the specific application. Some non-limiting examples of visibility include visibility as a continuously variable parameter, a stepped parameter, or a binary (visible/obscured) parameter. The visibility parameter can refer to one or more segments of an image or an entire image. Techniques from the field of machine learning can be used to determine the visibility of segments of the current image of the landing zone.

Two standard tools in the field of machine learning that can be used to determine the visibility of the landing zone are SVM and adaboost. These conventional tools use images with segments that are obscured and images with segments that are visible. This is known in the field as “training data”. The algorithms of these tools find criteria to identify the visibility of segments of the current image of the landing zone. Then as the tools process new images, these criteria are used to identify the visibility of segments of the current image of the landing zone. This concept is known as “supervised learning”, and is used not only in computer vision, but also in a many other implementations. These tools can take many criteria and choose the most informative ones automatically. It is possible to train these tools ahead of time using stored data or train them during a landing using real time data. These and other tools and conventional techniques are known in the field and other implementations will be obvious to one skilled in the art.

An innovative technique for determining the visibility of segments of an image involves using information about motion in the series of provided images to infer segments that are obscured by dust. This is particularly applicable where the provided images are a video sequence. The technique identifies motions that have different behaviors than the ground. According to one non-limiting example, an optical flow algorithm can be used to detect this behavior. Optical flow looks at pairs of images and finds the movement of each pixel from the first image to the second. Pixels that do not match the geometry of static objects, known as “epipolar geometry”, can be assumed to be pixels of moving objects, and can be classified as dust.

As has been described, warping two-dimensional images or having to switch between multiple sensor information and/or displays does not provide a consistent and accurately detailed view of the landing zone. Using a three dimensional model of the landing zone facilitates providing detailed information that can be accurately generated as the position of the vehicle changes. As the position of the vehicle changes, the three-dimensional model of the landing zone can be manipulated to be consistent with the perspective from the current position and attitude of the vehicle. Optionally, image registration maps the current image to the three-dimensional model. This perspective of the model is used in combination with the visibility information for the current image of the same perspective of the landing zone. Image registration facilitates knowing which segments of the current image correspond to which portions of the three-dimensional model. For segments of the current image where the landing zone is visible, those segments can be used in the rendered view to provide a real image of the visible segment of the landing zone. For segments of the current image where the landing zone is obscured, information from the three-dimensional model is used to facilitate rendering the view of the obscured segment of the landing zone. A variety of techniques can be used to render the view of the landing zone and in particular use information from the three-dimensional model to render the obscured segments of the current view.

In one implementation, as the vehicle approaches the landing zone, the captured images are stored in association with the surface of the three-dimensional model to which they correspond. During landing, when a segment of an image is obscured, the corresponding surfaces of the three-dimensional model can be used with the associated image to provide information to render a view of the obscured segment of the image. Optionally, when rendering a view using this implementation, the texture for each pixel in the rendered view is chosen from the images that were captured and stored in association with the surface of the three-dimensional model being used for rendering the pixel. In another implementation, as the vehicle approaches the landing zone, images are captured and processed to associate the textures from the images with corresponding surfaces of the three-dimensional model. According to a non-limiting example, the textures from the images are associated with a surface of the three-dimensional model—this is done “in advance”, or before the rendering of the view. The association data can be stored in a data structure known as an “atlas” of the reconstructed scene. When rendering a view, the texture information for the corresponding surface of the three-dimensional model is typically used without dependency on the point of view.

Optionally the view can be rendered by blending the current image or overlaying the current image (using transparency) with a simulated image from the three-dimensional model, with a previously captured image, or with a combination of simulations and previously captured images. According to a non-limiting example, the technique of overlaying an image, or portion of an image, can be used as segments of the current image start and then become more obscured. The transparency of the images can be varied depending on the application of the method to render a view of the landing zone. Techniques including combining, blending, overlaying, and other rendering techniques are known in the field of computer vision and computer graphics, particularly in the field of augmented reality. These and other techniques are known to one skilled in the art.

In one implementation, the above-described method is used to provide a view for a head-up-display (either fixed or helmet mounted). In such a case, the processing system is configured to process images captured during the vehicle's landing at the landing zone to determine the visibility of segments of the current image of the landing zone. Segments where the visibility is below a given threshold are considered obscured. The processing system uses the attitude and position of the vehicle in combination with the three-dimensional model to render at least a partial image. The partial image includes at least simulated segments derived at least in part from the three-dimensional model of the landing zone. The partial image is configured for providing the user with a perceived composite view. The perceived composite view derives from an updated real view of the landing zone and the at least partial image. The perceived composite view provides a view of the landing zone for assisting navigation of the vehicle.

The display system is configured to display the partial image to provide the perceived composite view to the user. In this case, the composite view is made up of at least the partial image with simulated portions, superimposed by use of the HUD on a direct view of the landing zone. As was described in reference to FIG. 5B, the dust cloud 106 is visible to the user, as the dust cloud is part of the real view the user sees of the landing zone. The user can also see the area of objects 402, as this area is not obscured by the dust cloud. The obstacles 400 that are not visible to the user in the real view are derived from the three-dimensional model as simulated segments in a partial image. The partial image is viewed directly through the HUD, allowing the user to perceive a composite of the real view and the obscured obstacles. Depending on the application, the display system, including but not limited to both the composite image and the HUD, can provide the user with additional information, as is known in the art.

In an alternate implementation, the three-dimensional model can be analyzed and information from the analysis provided to the pilot to assist with a successful landing. A non-limiting example is analyzing the model to locate a clear path and sufficiently large area to safely make an approach to the landing zone and land the vehicle. Other non-limiting examples are detecting obstructions or detecting potential collisions. This information can then be provided to the pilot of the vehicle in a manner suitable to the application, including placing visual indicators on the rendered view, or providing written or verbal instructions from a separate indicator.

This system and method can be applied to other situations in which the aircraft encounters conditions similar to those described for a dust landing. One non-limiting example is where the aircraft is landing during windy conditions and the landing zone is obscured due to particles blown by the wind. Another non-limiting example is the case where it is necessary to perform a stealth landing at night—where visible light from the aircraft cannot be used. In this case, one option is to illuminate the landing zone with infrared light (IR) and use IR imaging devices to capture images of the landing zone. This implementation is also applicable in other low-light conditions where an alternate illumination is necessary.

It will be appreciated that the above descriptions are intended only to serve as examples, and that many other embodiments are possible within the scope of the present invention as defined in the appended claims.

What is claimed is:

1. A system for assisting navigation of a vertical takeoff and landing vehicle in circumstances where there is a possibility of the view being obscured, comprising:
(a) an image capture system comprising at least one image capture device, said image capture system associated with the vehicle and configured to provide images of a landing zone;
(b) a navigation system providing the attitude and position of the vehicle;
(c) a processing system comprising one or more processors, said processing system being configured to:
(i) provide a three-dimensional model of the landing zone;
(ii) process images captured during the vehicle's landing at the landing zone to determine the visibility of segments of the current image of the landing zone; and
(iii) render using said attitude and position an at least partial image comprising at least simulated segments derived at least in part from said three-dimensional model of the landing zone, said at least partial image configured for providing the user with a perceived composite view for assisting navigation of the vehicle, said perceived composite view comprising said simulated segments and an updated real view of at least part of the landing zone; and
(d) a display system configured to display said at least partial image so as to provide the perceived composite view to the user.

2. The system of claim 1 wherein the display system is configured to display said at least partial image as a composite of said simulated segments with segments of said current image for visible segments of the landing zone.

3. The system of claim 1 wherein said display system includes a head up display (HUD), and wherein said at least partial image of the landing zone is viewed directly through the HUD.

4. The system of claim 1 wherein said image capture system includes an image capture device sensitive to visible light.

5. The system of claim 1 wherein said image capture system includes a forward-looking infrared (FLIR) camera.

6. The system of claim 1 wherein said image capture system includes RADAR that provides information for generation of said three-dimensional model of the landing zone.

7. The system of claim 1 wherein said image capture system includes LADAR that provides information for generation of said three-dimensional model of the landing zone.

8. The system of claim 1 wherein a digital terrain map (DTM) provides information for generation of said three-dimensional model of the landing zone.

9. The system of claim 1 wherein said image capture system includes a plurality of image capture devices.

10. The system of claim 1 wherein said three-dimensional model is provided by processing a first plurality of said images during the vehicle's approach to the landing zone.

11. The system of claim 1 wherein said three-dimensional model is provided to said processing system from storage.

12. The system of claim 11 wherein a second plurality of images are captured during the vehicle's approach to the landing zone and said second plurality of images are used to update said three-dimensional model.

13. The system of claim 1 further including a user actuated trigger for initiating said processing.

14. The system of claim 1 wherein the processing system is further configured to monitor said visibility of segments of the current image of the landing zone and based on a visibility threshold activate the rendering process and said display system.

15. The system of claim 1 wherein the system is operationally connected to a system providing flight parameters and wherein the processing system is further configured to monitor the flight parameters and based on a combination of flight parameters activate said system for assisting navigation of the vehicle.

16. The system of claim 15 wherein the flight parameters include altitude and velocity.

17. The system of claim 15 wherein the flight parameters include altitude and direction of flight.

18. The system of claim 1 wherein said navigation system determines said attitude and position of the vehicle at least in part from said images.

19. The system of claim 1 wherein said navigation system determines said attitude and position of the vehicle at least in part from an inertial navigation system (INS).

20. The system of claim 1 wherein during the vehicle's approach to the landing zone said images are stored in association with the surfaces of said three-dimensional model of the landing zone to which they correspond and said view of the landing zone is rendered using textures from said images.

21. A method for assisting navigation of a vertical takeoff and landing vehicle in circumstances where there is a possibility of the view being obscured, the method comprising the steps of:
(a) providing images of a landing zone during a vehicle's approach to the landing zone;
(b) providing the attitude and position of the vehicle;
(c) providing a three-dimensional model of the landing zone;
(d) processing said images captured during the vehicle's landing at the landing zone to determine the visibility of segments of the current image of said landing zone;
(e) rendering using said attitude and position an at least partial image comprising at least simulated segments derived at least in part from said three-dimensional model of the landing zone, said at least partial image configured for providing the user with a perceived composite view for assisting navigation of the vehicle, said perceived composite view comprising said simulated segments and an updated real view of at least part of the landing zone; and
(f) displaying said at least partial image so as to provide the perceived composite view to the user.

22. The method of claim 21 wherein said at least partial image is displayed as a composite of said simulated segments with segments of said current image for visible segments of the landing zone.

23. The method of claim 21 wherein said at least partial image of the landing zone is displayed for viewing directly through a head-up-display (HUD).

24. The method of claim 21 wherein said images are visible-light images.

25. The method of claim 21 wherein said images are infrared images.

26. The method of claim 21 wherein said three-dimensional model of the landing zone is generated from RADAR information.

27. The method of claim 21 wherein said three-dimensional model of the landing zone is generated from LADAR information.

28. The method of claim 21 wherein said three-dimensional model of the landing zone is generated from digital terrain map (DTM) information.

29. The method of claim 21 wherein said three-dimensional model is provided by processing a first plurality of said images during the vehicle's approach to the landing zone.

30. The method of claim 21 wherein said three-dimensional model is provided from storage.

31. The method of claim 21 wherein a second plurality of images are captured during the vehicle's approach to the landing zone and said second plurality of images are used to update said three-dimensional model.

32. The method of claim 21 wherein said visibility of segments of the current image of said landing zone are monitored and based on a visibility threshold said rendering and said display steps are initiated.

33. The method of claim 21 wherein flight parameters are provided and further comprising monitoring said flight parameters and based on a combination of flight parameters initiating the method for assisting navigation of the vehicle.

34. The method of claim 33 wherein the flight parameters include altitude and velocity.

35. The method of claim 33 wherein the flight parameters include altitude and direction of flight.

36. The method of claim 21 wherein said attitude and position of the vehicle are provided at least in part from said images.

37. The method of claim 21 wherein said attitude and position of the vehicle are provided at least in part from an inertial navigation system (INS).

38. The method of claim 21 wherein during the vehicle's approach to the landing zone said images are stored in association with the surfaces of said three-dimensional model of the landing zone to which they correspond and said view of the landing zone is rendered using textures from said images.
